(19) United States
(12) Patent Application Publication
(10) Pub. No.: US 2018/0047007 A1
(43) Pub. Date: Feb. 15, 2018

(54) SYSTEM AND METHOD FOR PAYING FOR GOODS AT A DOOR

(71) Applicant: Wal-Mart Stores, Inc., Bentonville, AR (US)

(72) Inventors: Donald R. High, Noel, MO (US); Matthew Allen Jones, Bentonville, AR (US); Chandrashekar Natarajan, Valencia, CA (US); Nicholaus Adam Jones, Fayetteville, AR (US)

(21) Appl. No.: 15/673,244

(22) Filed: Aug. 9, 2017

Related U.S. Application Data
(60) Provisional application No. 62/372,500, filed on Aug. 9, 2016.

(51) Int. Cl. G06Q 20/20; G06K 7/10; G06K 7/12; G06Q 20/40

(52) U.S. Cl. CPC G06Q 20/208; G06Q 20/40145; G06K 7/10297; G06K 7/12

(57) ABSTRACT

Provided is a payment system for paying for goods at a door of a store. The system includes a purchase tunnel that has an entrance door or gate, an exit door or gate and a scanning device. The scanning device automatically scans and reads product identifying elements for all products within a cart. A biometric reader may be electronically coupled to the purchase tunnel, wherein the entrance door or gate opens in response to a customer inputting biometric data through the biometric reader. The system includes an entrance sensor coupled to the purchase tunnel to determine when a customer enters the purchase tunnel, wherein the entrance door or gate closes in response to the sensor determining that the customer entered the purchase tunnel. The system also includes a payment hub, wherein payment is automatically processed by the payment hub upon confirmation of scanning all of the products within the cart.

### CROSS REFERENCE TO RELATED APPLICATION[S]

This application claims priority to U.S. Provisional Patent Application “SYSTEM AND METHOD FOR PAYING FOR GOODS AT A DOOR,” Ser. No. 62/372,500, filed Aug. 9, 2016, the disclosure of which is hereby incorporated entirely herein by reference.

### FIELD OF THE INVENTION

The invention relates generally to payment system, and more specifically, to systems and methods for paying for goods at a door.

### BACKGROUND

One of the biggest issues a customer faces when shopping at a store is the time it takes to actually purchase products. Often, there are never enough cashiers to deal with the volume of customers. Self-check lines are always limited when a customer has too many items. Once a customer selects products to purchase and puts them in a cart, the customer then chooses a cashier, waits in a line and purchases the goods. Accordingly, there is a need for a quick and efficient payment method without standing in line.

### BRIEF SUMMARY

In one aspect, provided is a payment system for paying for goods at a door of a store, the system comprising: a purchase tunnel comprising an entrance door or gate, an exit door or gate and a scanning device, wherein the scanning device automatically scans and reads product identifying elements for all products within a cart; a biometric reader electronically coupled to the purchase tunnel, wherein the entrance door or gate opens in response to a customer inputting biometric data through the biometric reader; an entrance sensor coupled to the purchase tunnel to determine when a customer enters the purchase tunnel, wherein the entrance door or gate close in response to the sensor determining that the customer entered the purchase tunnel; and a payment hub, wherein payment is automatically processed by the payment hub upon confirmation of scanning all of the products within the cart.

Another aspect includes a method of using a payment system for paying at a door of a store, the method comprising: performing a biometric scan of a customer's biometric data using a biometric scanner of a payment system; authenticating that the scanned biometric data matches a stored biometric data associated with a registered customer; automatically opening an entrance door or gate of a payment tunnel of the payment system in response to authenticating the registered customer; automatically closing the entrance door or gate in response to a door sensor determining that the customer and associated cart have entered the payment tunnel; automatically scanning all products within the cart; and automatically processing payment for the products in the cart in response to the system determining that all products in the cart have been scanned.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a flow diagram illustrating a method for registering a customer with a payment system, in accordance with some embodiments.

FIG. 2 is an illustrative view of a payment system in a retail store, in accordance with some embodiments.

FIG. 3 is a flow diagram illustrating a method for using a payment system, in accordance with some embodiments.

### DETAILED DESCRIPTION

Brick-and-mortar stores provide customers the ability to walk about the store, perusing items of interest, touching items for purchase, smelling items, listening to items, trying on items determining spacial qualities of the items, etc. However, the check out process is often time consuming where the number of cashiers is often limited and the customer selects a line to wait in for a cashier hoping they selected the fastest line. Then the customer can finally pay and leave the store with the purchased goods.

The present inventive concepts provide a secure payment system that allows a customer to quickly and efficiently checkout, pay and exit the store. The payment system allows for a user to easily and quickly checkout without the need for experiencing the conventional check out process currently offered in stores.

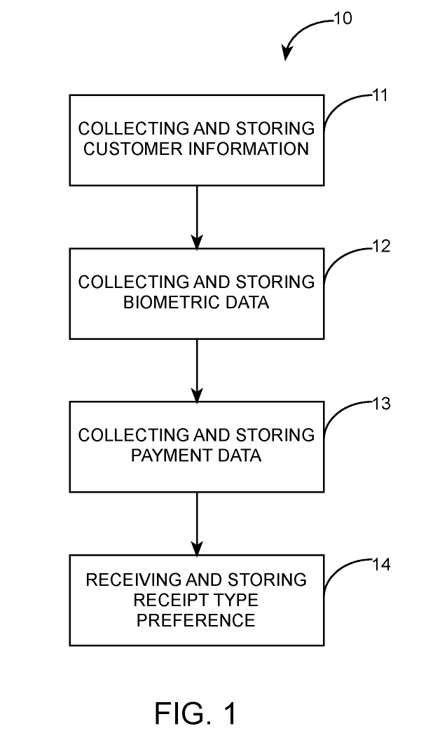

FIG. 1 depicts a block diagram of a registration process 10, in accordance with embodiments. Before a customer can utilize the payment system, the customer must first enroll or register for use with the system. The process of registration includes, but is not limited to the registration process 10 that includes collecting and storing customer information (Step 11), wherein the customer information includes at least a name, an email address and a phone number. This information is stored on a server that is accessible by the payment system in order to confirm the customer as registered with the payment system. The registration process 10 further includes collecting biometric data associated with the registered customer (Step 12). Step 12 of collecting biometric data may include collecting a handprint, a palm print, a finger print, a retinal scan, a voice print, a facial scan, a DNA sequence and the like. The collected data is stored on the server and accessible by the payment system in order to identify and authenticate the customer associated with the biometric data. Registration process 10 may further include collecting and storing payment data (Step 13). The payment data may be bank account information, credit card information, membership card information, loyalty card information and the like. This payment data is utilized to effect payment of the products selected by the customer during the shopping trip. The registration process 10 may then include a receiving and storing customer receipt type preference (Step 14). This establishes the type of receipt the customer prefers and will be provided with after the payment system process the payment, such as a paper receipt or an electronic receipt. The customer may also select the type of delivery if an electronic receipt is selected at the registration process.

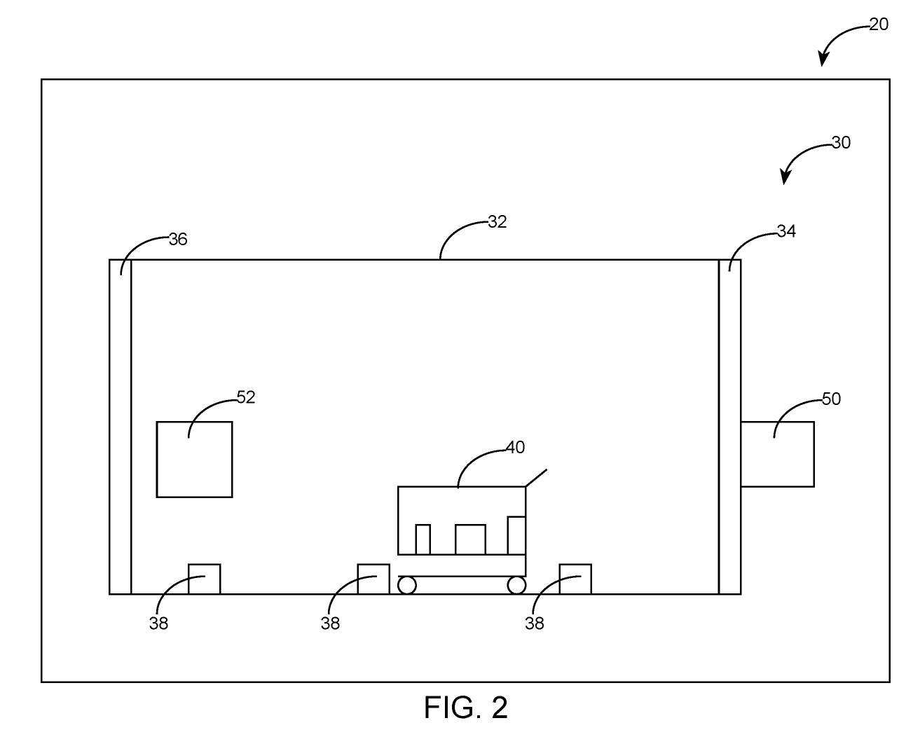

Referring to the drawings, FIG. 2 depicts an illustrative view of a store 20 equipped with a payment system 30 according to embodiments. The payment system may include a payment tunnel 32, wherein the payment tunnel includes an entrance door or gate 34 and an exit door or gate 36. The payment tunnel 32 includes scanning devices 38, wherein the scanning devices 38 operate to identify and read tags or product identifying elements on products within a shopping cart 40. The scanning devices 38 may be RFID sensors, magnetic ink sensors, and/or other sensors for identifying products with the cart 40. These other sensors may have the capability to identify products to be purchase through video analytics, Short wave HID, customer scanned device, person shopper scanned device, associate scanned device, smart shelves that provide information when a product is removed, a system determining the shopping cart location and weight of all items and measure the change to determine what is in the cart. The payment system 30 may require barcodes in the visual spectrum and not in the visual spectrum to be located on all sides of the products and a 6 direction scanner to detect what is in the basket, video analytics of cart contents coupled with other data points mentioned above may operate together to ensure that all of the products are accounted for and scanned by the payment tunnel 32 in order to determine the total payment needed in order to purchase the goods in the cart 40. Additionally, the payment system 30 may also include scan and go data, wherein a customer scans items as the customer shops and places goods in the cart. The products are then scanned prior to entering the payment tunnel 32 and the need for scanning of items may not be needed, or may be utilized as a check system to ensure all items are accounted for with the scan and go data.

The payment system 30 may include a biometric reader 50 located by an entrance door or gate 34 of the payment tunnel 32. The biometric reader 50 operates to collect a biometric reading from the customer, such as, but not limited to a hand print, a palm print, a finger print, a retinal scan, a voice print, a facial scan, a DNA sequence and the like. The system 30 may then compare the collected biometric reading with the stored biometric data in order to determine the customer accessing the payment tunnel 32 and authenticate that the customer is registered and that the payment system 30 has all of the needed information for processing payment. Once the biometric reader 50 authenticates the customer, the entrance door or gate 34 of the payment tunnel 32 opens and allows the customer to enter with the cart 40. While a biometric reader 50 is depicted, it will be understood that there may be additional forms of identification that a customer may utilize to gain access to the payment tunnel, such as an identification card, a PIN, or the like.

As the customer enters the payment tunnel 32 with the cart 40, the entrance door or gate 34 behind the customer will close. This enables security so people do not get tailgated into the tunnel. If another unauthorized person enters the area the customer is responsible to request assistance to have the person and their merchandise removed. However, since many customers shop with more than one person, the customer may authorize more than one person in the payment tunnel 32, such as children, spouse, friend and the like.

Once in the payment tunnel 32, the payment tunnel 32 operates the sensors to scan each item in the cart 40. For example, and without limitation, products in the cart may each be marked uniquely. This unique marking may include magnetic ink, RFID tags, or some type of tag, which can be read without adjusting the products within the cart. In some embodiments, the products do need to be visible to the scanning devices 38. In the payment tunnel 32, general UPC codes will be not be needed due to the possibility of someone purchasing multiples and the system not picking up the correct amount of items. Each individual product or item has a unique code that may be invisible to the naked eye but will enable the payment system 30 to track each individual item.

Once the payment tunnel 32 confirms that all products have been scanned, the payment system 30 may utilize a payment hub 52 to collect payment. In some embodiments, the payment hub 52 operates as a typical point of sale where the customer utilizes cash or a card to pay for the products. In other embodiments, the payment hub 52 operates to automatically process payment utilizing payment data associated with the customer and stored on the server. The payment data may be accessed by the payment system 30 and payment may then be processed. Upon successful payment, the exit door or gate 36 opens and the customer may leave with the cart 40. The payment system 30 may then supply a receipt in accordance with the customer receipt preference, such as a paper receipt, or an e-receipt sent to the registered customer's email for record keeping, product returns, and warranties.

Another embodiment of a payment tunnel that may be used within this system has been disclosed in U.S. Pat. No. 7,997,486, the disclosure of which is hereby incorporated entirely herein by reference.

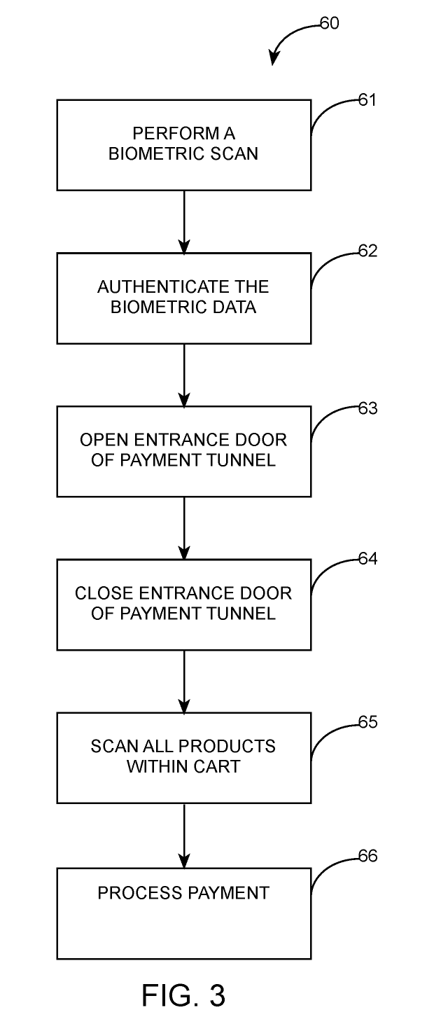

FIG. 3 depicts a flow chart of a method 60 of using a payment system for paying at a door of a store. The method 60 includes performing a biometric scan of a customer's biometric data using a biometric scanner of a payment system (Step 61); authenticating that the scanned biometric data matches a stored biometric data associated with a registered customer (Step 62); automatically opening an entrance door or gate of a payment tunnel of the payment system in response to authenticating the registered customer (Step 63); automatically closing the entrance door or gate in response to a door sensor determining that the customer and associated cart have entered the payment tunnel (Step 64); automatically scanning all products within the cart (Step 65); and automatically processing payment for the products in the cart in response to the system determining that all products in the cart have been scanned (Step 66). The method 60 may further include registering a customer to use the payment system. The method 60 may also include automatically identifying an unauthorized customer entering the payment tunnel with an authorized customer.

In performing the method 60, the system may be able to process various types of scanned biometric data. The scanned biometric data may include one or more of a handprint scan, a palm scan, a finger print scan, a retinal scan, a facial scan, a voice print scan and a DNA scan.

Step 65 of automatically scanning all products within the cart occurs while the customer pushes the cart through the payment tunnel. Further, Step 65 includes automatically scanning all products within the cart includes reading product identifying elements for all products within the cart. Additionally, determining whether all products in the cart are scanned further includes using video analytics system for determining that all items in the cart are visible.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A payment system for paying for goods at a door of a store, the system comprising:
a purchase tunnel comprising an entrance door or gate, an exit door or gate and a scanning device, wherein the scanning device automatically scans and reads product identifying elements for all products within a cart;
a biometric reader electronically coupled to the purchase tunnel, wherein the entrance door or gate opens in response to a customer inputting biometric data through the biometric reader;
an entrance sensor coupled to the purchase tunnel to determine when a customer enters the purchase tunnel, wherein the entrance door or gate close in response to the sensor determining that the customer entered the purchase tunnel; and
a payment hub, wherein payment is automatically processed by the payment hub upon confirmation of scanning all of the products within the cart.

2. The system of claim 1, wherein the biometric reader comprises one or more of a handprint scanner, palm scanner, finger print scanner, a retinal scanner, facial scanner, voice print scanner and a DNA scanner.

3. The system of claim 1, wherein the product identifying elements comprise magnetic ink.

4. The system of claim 1, wherein the product identifying elements comprise RFID tags.

5. The system of claim 1, wherein the product identifying elements comprise short wave HID.

6. The system of claim 1, wherein the product identifying elements comprise bar codes in the visual spectrum.

7. The system of claim 1, wherein the product identifying elements comprise bar codes not in the visual spectrum.

8. The system of claim 1, further comprising a video analytics system for determining that all items in the cart are visible.

9. A method of using a payment system for paying at a door of a store, the method comprising:
performing a biometric scan of a customer's biometric data using a biometric scanner of a payment system;
authenticating that the scanned biometric data matches a stored biometric data associated with a registered customer;
automatically opening an entrance door or gate of a payment tunnel of the payment system in response to authenticating the registered customer;
automatically closing the entrance door or gate in response to a door sensor determining that the customer and associated cart have entered the payment tunnel;
automatically scanning all products within the cart; and
automatically processing payment for the products in the cart in response to the system determining that all products in the cart have been scanned.

10. The method of claim 9, further comprising registering a customer to use the payment system.

11. The method of claim 10, wherein registering the customer comprises collecting and storing customer information, biometric data and payment data.

12. The method of claim 9, wherein the scanned biometric data comprises one or more of a handprint scan, a palm scan, a finger print scan, a retinal scan, a facial scan, a voice print scan and a DNA scan.

13. The method of claim 9, further comprising automatically identifying an unauthorized customer entering the payment tunnel with an authorized customer.

14. The method of claim 9, wherein automatically scanning all products within the cart occurs while the customer pushes the cart through the payment tunnel.

15. The method of claim 14, wherein automatically scanning all products within the cart includes reading product identifying elements for all products within the cart.

16. The method of claim 15, wherein the product identifying elements comprise magnetic ink.

17. The method of claim 15, wherein the product identifying elements comprise RFID tags.

18. The method of claim 15, wherein the product identifying elements comprise short wave HID.

19. The method of claim 15, wherein the product identifying elements comprise bar codes in the visual spectrum.

20. The method of claim 15, wherein the product identifying elements comprise bar codes not in the visual spectrum.
